(19) United States
(12) Patent Application Publication
(10) Pub. No.: US 2026/0161910 A1
(43) Pub. Date: Jun. 11, 2026

(54) Automatic Printer Calibration

(71) Applicant: Zebra Technologies Corporation, Lincolnshire, IL (US)

(72) Inventors: Matthew D. Corvese, Cranston, RI (US); Stephen A. Carello, Johnston, RI (US); Patrick J. Hegarty, Dedham, MA (US)

(21) Appl. No.: 18/970,235

(22) Filed: Dec. 5, 2024

(51) Int. Cl. G06K 15/02; B41J 11/00; B41J 11/04; B41J 29/393; G06T 7/00

(52) U.S. Cl. CPC G06K 15/027; B41J 11/009; B41J 11/04; B41J 29/393; G06T 7/0004; B41J 2029/3935; G06T 2207/30144

(57) ABSTRACT

An example printer includes: a printhead configured to print indicia onto a print media according to a set of print parameters; an image sensor configured to capture image data representing the printed indicia on the print media; a controller interconnected with the printhead and the image sensor, the controller configured to: control the printhead to print a calibration pattern; obtain the image data from the image sensor representing the printed calibration pattern; analyze the image data to determine whether the printed calibration pattern meets a threshold calibration condition; and adjust the set of print parameters until the printed calibration pattern meets the calibration threshold to calibrate the printer

### BACKGROUND

Printers use printheads to print indicia onto media. The printheads are controlled according to print parameters which are typically experimentally determined and set as a factory setting for each printhead. However, the printheads may interact differently with different types of media, resulting in non-optimal print parameters for different types of media.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a schematic diagram of a printer in accordance with the present disclosure.

FIG. 2 is a block diagram of certain internal hardware components of the printer of FIG. 1.

FIG. 3 is a flowchart of a method for automatic printer calibration.

FIGS. 4A and 4B are schematic diagrams of example calibration patterns.

FIG. 5 is a flowchart of an example method of component calibration for the printer calibration operation.

FIG. 6 is a schematic diagram of an example calibration target.

FIG. 7 is a schematic diagram of an example print media.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a printer comprising: a printhead configured to print matter onto a print medium according to a set of print parameters; an image sensor configured to capture image data representing the printed matter on the print medium; a controller in communication with the printhead and the image sensor, the controller configured to: control the printhead to print a calibration pattern on the print medium; obtain the image data from the image sensor representing the printed calibration pattern; analyze the image data, e.g., via a trained machine learning model, to determine whether the printed calibration pattern meets the threshold calibration condition; and adjust the set of print parameters, e.g., based on an output of the trained machine learning model, until the printed calibration pattern meets the calibration threshold to calibrate the printer.

Additional examples disclosed herein are directed to a method comprising: printing a calibration pattern on a print media according to a set of print parameters; obtaining image data representing the printed calibration pattern; analyzing the image data, e.g., via a trained machine learning model, to determine whether the printed calibration pattern meets a threshold calibration condition; and adjusting the set of print parameters, e.g., based on an output of the trained machine learning model, until the printed calibration pattern meets the calibration threshold to calibrate the printer.

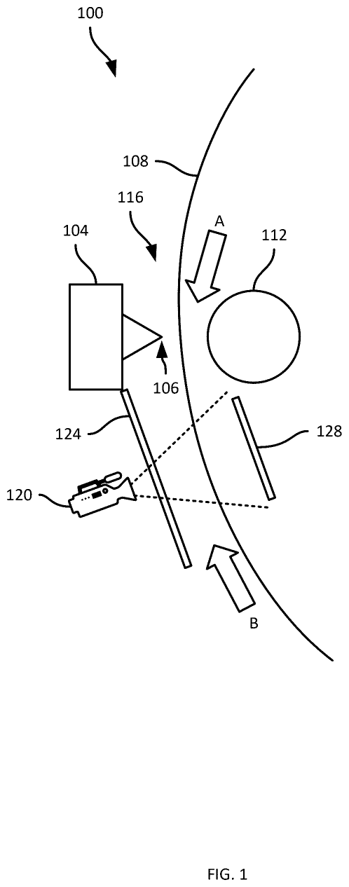

FIG. 1 depicts a partial cross section depicting certain internal components of an example printer 100 for automatic printer calibration in accordance with the teachings of this disclosure. The printer 100 includes a printhead 104 configured to print matter onto print media 108, and a platen roller 112 configured to feed the print media 108 (also referred to herein as simply the media 108) past the printhead 104 to allow the printhead 104 to print the matter onto the media 108. For example, the printer 100 may be configured to print on media supplies such as paper, labels, fan-feed labels, identity cards, or the like. The platen roller 112 may be driven (e.g., by a motor or the like) to pull the media 108 along a media path 116 which may be defined by surfaces, rollers, and the like, such as a guide roller (e.g., a passive or non-driven roller), and the like, and through a nip formed by the printhead 104 and the platen roller 112 where the printhead 104 is configured to print indicia onto the media 108. The processed media 108 with the printed indicia may then be dispensed at an outlet of the printer 100.

The printhead 104 may be an effector assembly, including an array of effector elements, such as discrete thermal elements also referred to as dots 106. The array, for example, can be a linear array extending transversely across the media path 116 along which the media 108 travels. For direct thermal printers, the effector elements or dots 106 can be individually activated to apply heat to corresponding portions of the media 108 to form indicia on the print media. For thermal transfer printers, a ribbon can traverse the nip with the media 108 and application of heat to a portion of the media 108 and the ribbon can cause the transfer of pigment from the ribbon to the media 108 to form indicia on the print media.

To print indicia onto the media 108, each of the dots 106 of the printhead 104 may be activated in accordance with a set of print parameters such as, but not limited to, a binary activation state (i.e., whether or not a given dot is to be activated to apply pigment to the media 108 in a corresponding region or to remain inactive such that a corresponding region of the media 108 remains unpigmented), a burn time (i.e., a time period for which the dot is turned on), a pre-heat time (i.e., a time period prior to application of the dot to the media 108 to heat), a pre-heat pulse rate (i.e., a rate at which the dot is turned on and off, or pulsed, during the pre-heat time), a neighbor on-time (i.e., a time period for which a neighboring dot is turned on to allow residual heat to bleed into the target dot), and a neighbor pulse rate (i.e., a rate at which the neighboring dot is turned on and off, or pulsed). Different print parameters may affect the resulting appearance of the printed indicia on the media 108, for example based on the media type (e.g., as affected by glaze type on the media 108, the thickness of the media 108, etc.), based on manufacturing and operational tolerances of the individual printhead 104 itself, and the like. Accordingly, different print parameters may optimize the appearance of the printed indicia for different combinations of printer 100 and media 108.

The calibration process may typically be performed to define the print parameters as a factory setting, according to an expected and/or average media type or types. However, this may reduce the optimization of the print parameters, for example for different print jobs employing different media types, changes or replacements of components of the printer 100, or the like. In particular, the calibration process typically includes iterations of printing the media and manual adjustments of the print parameters, which can be time consuming, can result is waste (e.g., using more media than necessary for calibration), and/or can result in human error.

In accordance with the present disclosure, the printer 100 further includes an image sensor 120 configured to capture image data representing the printed indicia on the media 108. The image sensor 120 may be any suitable image sensor, such as a complementary metal-oxide-semiconductor (CMOS) imager/camera, charge coupled device (CCD) imager/camera, one or more contact image sensors (CIS), or the like. The image sensor 120 is located along the media path 116, and may be upstream or downstream of the printhead 104. For example, when the media 108 is fed along the media path 116 in a direction A, the image sensor 120 is downstream of the printhead 104 and may capture the image data of the printed indicia as the media 108 proceeds along the media path 116. In another example, the media 108 may be fed along the media path 116 in a direction B (i.e., in a different printer 100 with a different configuration of internal components), the image sensor 120 is upstream of the printhead 104. To capture image data of the printed indicia, the platen roller 112 may be configured to reverse directions and retract or pull back the media 108 along the media path 108 after printing by the printhead 104 until the printed indicia is within the field of view (FOV) of the image sensor 120 to capture the image data.

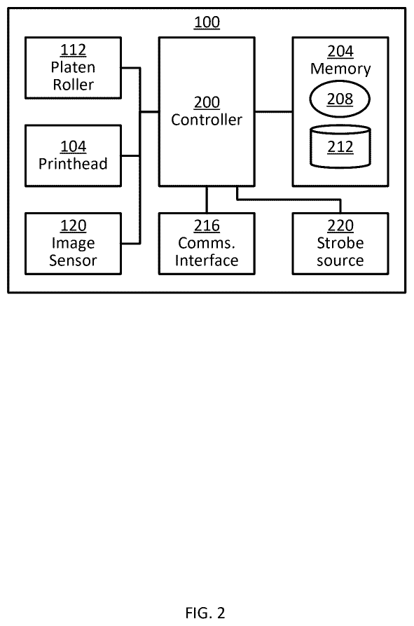

In some examples, the image sensor 120 may be exterior to the media path 116, and hence the media path 116 may be defined by a surface including a window 124 through which the image sensor 120 may capture image data representing printed indicia on the media 108 in the media path 116. Further, in some examples, the printer 100 may further include a backing 128 defining a portion of the media path 116 opposite the image sensor 120. That is, the media 108 may be configured to pass along the media path 116 between the image sensor 120 and the backing 128. The backing 128 may include a light source to act as a backlight during the image capture operation of the image sensor. In other examples, the printer 100 may include a strobe source associated with the image sensor 120 (as described in relation to FIG. 2) to illuminate a front side of the media, relative to the image sensor 120. The selection of illumination via the strobe source or the backlight may be performed based on the type of image analysis to be performed. In other examples, the backing 128 may include one or more predefined calibration targets to calibrate the image sensor 120. For example, the calibration target may include a horizontal and vertical cross hair, a 2-dimensional barcode or having predefined dimensions, or the like. In operation, the image sensor 120 may capture image data representing the calibration target (i.e., before the media 108 is fed along the media path 116 between the image sensor 120 and the calibration target) and maps the image pixels to the known dimensions of the calibration target.

In operation, the printer 100 may automatically self-calibrate by analyzing the image data representing the printed indicia via a trained machine learning model, and more particularly, a printed calibration pattern and adjusting the print parameters, e.g., based on an output of the trained machine learning model, until the printed calibration pattern meets a calibration condition. For example, the calibration condition may include the calibration pattern being within a threshold size range, the calibration pattern meeting a neighbor tuning condition, or the like. The trained machine learning model can be trained on sets of input calibration patterns, print parameters, and printed calibration patterns. As described herein, the printer may use an iteratively process for calibration, and each iteration, the printer 100 can print a print calibration pattern on print media, obtain an image of the printed calibration, input the print calibration pattern, the image of the printed calibration pattern, and print parameters into the trained machine learning model, which generates an output including one or more adjust values for the print parameters, and controls the printhead to print the print calibration pattern again on print media using the one or more adjust values. As an example, the trained machine learning model can output an adjust value for a burn time, a pre-heat time, a pre-heat pulse rate, a neighbor on-time, or a neighbor pulse rate associated with one or more dots 106 of the printhead 104.

Turning now to FIG. 2, a block diagram of certain internal components of the printer 100 is depicted. The printer 100 includes a controller 200 such as a central processing unit (CPU), graphics processing unit (GPU), microcontroller, series of cooperating processors, application-specific integrated circuit (ASIC), or the like, interconnected with a non-transitory computer-readable storage medium, such as a memory 204. The memory 204 includes a combination of volatile memory (e.g., random access memory or RAM) and non-volatile memory (e.g., read only memory or ROM, electrically erasable programmable read only memory or EEPROM, flash memory). The controller 200 and the memory 204 may each comprise one or more integrated circuits.

The memory 204 stores computer-readable instructions for execution by the controller 200, including one or more applications which, when executed, configure the controller 200 to perform the various functions of the printer 100. In particular, the memory 204 stores an application 208 which, when executed by the controller 200, configures the controller 200 to perform various functions discussed below in greater detail and related to the calibration operation of the printer 100. Some or all of the application 208 may also be implemented as a suite of distinct applications.

In particular, the application 208 may configure the controller 200 to apply image analysis to the image data representing the printed calibration pattern to determine whether the printed calibration pattern meets a threshold calibration condition. Based on the determination, the application 208 may configure the controller 200 to adjust the print parameters. The controller 200 may iteratively print calibration patterns and adjust the print parameters until the printed calibration pattern meets the threshold calibration condition.

In some examples, the image analysis and adjustment of the print parameters may be performed by a trained machine learning model or an ensemble of trained machine learning models. As one example, the image analysis and adjustment of the print parameters may be performed by a trained machine learning model operating via the YOLOv5 model, or other suitable neural networks or models. In particular, the model may be trained on sets of input calibration patterns (i.e., calibration patterns to be printed), print parameters used to print the calibration patterns, and the resulting printed calibration pattern. In some examples, the training data may additionally be annotated with a media type or other relevant data.

Those skilled in the art will appreciate that the functionality implemented by the controller 200 may also be implemented by one or more specially designed hardware and firmware components, such as a field-programmable gate array (FPGAs), application-specific integrated circuits (ASICs) and the like in other embodiments. In an embodiment, the controller 200 may be, respectively, a special purpose processor which may be implemented via dedicated logic circuitry of an ASIC, an FPGA, or the like in order to enhance the processing speed of the operations discussed herein.

The memory 204 also stores a repository 212 storing rules and data for the calibration and/or print operation of the printer 100. In particular, the repository 212 may store one or more calibration patterns (e.g., defined as a bitmap or the like) to be printed onto the media for the calibration operation, as will be described in further detail below. The repository 212 may further store the print parameters for the printer 100 as a result of the calibration operation. In some examples, the print parameters may be associated with particular media types.

The printer 100 further includes a communications interface 216 enabling the printer to exchange data with other computing devices. The communications interface 216 is interconnected with the controller 200 and includes suitable hardware (e.g., transmitters, receivers, network interface controllers, ports, circuitry and the like) allowing the printer 100 to communicate with other computing devices. The specific components of the communications interface 216 are selected based on the types of links that the printer 100 is to communicate over. For example, the printer 100 may be enabled for wireless communications (e.g., via short-range wireless communications, wireless local or wide area network connections, or the like), wired communications, combinations of wired and wireless communications, and the like.

The printer 100 further includes a strobe source 220 configured to strobe or flash light for the image capture operations of the image sensor 120. The strobe source 220 may include any suitable light source and may be controlled by the controller 200 to flash at varying different illumination levels. In particular, the strobe source 220 may illuminate the field of view of the image sensor 120 to facilitate the calibration operation of the printer 100.

In operation, the indicia applied to the media 108 by the printhead 104 can be provided to the printhead 104 by the controller 200. The controller 200 may, for example, receive print data defining text, images, or the like to be applied to the media 108 from a host computing device (e.g., a desktop computer, a smartphone, or the like) via the communications interface 216. In other examples, the controller 200 may retrieve the print data defining the calibration pattern to be applied to the media 108 from the repository 212 for the calibration operation. The controller 200 may be configured to control the printhead 104 to apply to the indicia corresponding to the print data to the media 108.

The printer 100 may further include one or more input and/or output devices (not shown), such as buttons, keypads, touch-sensitive display screens, speakers, and the like for allowing a user to interface with the printer 100.

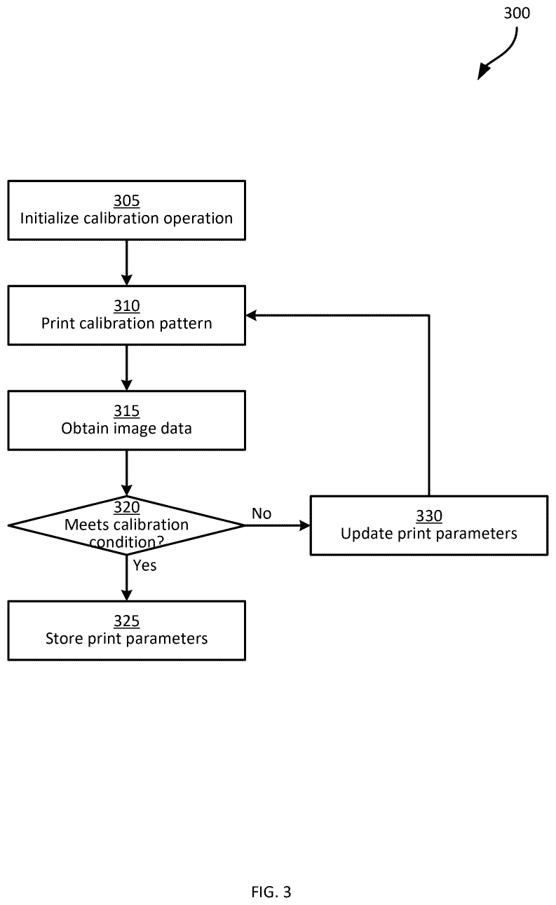

Turning to FIG. 3, the functionality implemented by the printer 100 will be discussed in greater detail. FIG. 3 illustrates a flowchart of a method 300 of automatically calibrating a printer in accordance with the present disclosure. The method 300 is described below in conjunction with its performance in the printer 100, and particularly by the controller 200 via execution of the application 208. In other examples, some or all of the method 300 may be performed by other suitable devices or systems.

The method 300 is initiated at block 305, where the printer 100 is configured to initialize a calibration operation. For example, the calibration operation may be initialized in response to a command from a host computing device or input at the printer 100 itself. In response to initializing the calibration operation, the printer 100 is configured to obtain the calibration pattern from the repository 212. In some examples, the initialization of the calibration operation may further include calibrating the image sensor 120, for example, using the calibration target to map pixels of the captured image data to actual widths, detection of the media type of the media 108 or the like.

At block 310, the printer 100 is configured to print the calibration pattern on the media 108 using a set of print parameters. In particular, the controller 200 may control the printhead 104 to print the calibration pattern on the media 108, for example by sending a sequence of commands to the printhead 104 to activate the dots of the printhead 104 in accordance with the set of print parameters. The selected print parameters may be a set of default print parameters (e.g., to be used at initialization of the calibration operation), a set of current print parameters (e.g., a set of print parameters most recently used in a prior print operation), a set of print parameters as stored in the repository 212 based on the detected media type, or the like.

At block 315, the printer 100 is configured to obtain image data representing the printed calibration pattern. For example, the controller 200 may control the image sensor 120 to capture the image data. In examples where the image sensor 120 is downstream of the printhead 104, the controller 200 may simply control the image sensor 120 to capture the image data during the print operation, according to a speed at which the media 108 is being fed, when the printed calibration pattern is within the field of view of the image sensor 120. In examples where the image sensor 120 is upstream of the printhead 104, the controller 200 may control the platen roller 112 to retract the media 108 along the media path 116 until the printed calibration pattern is within the field of view of the image sensor 108, and then may control the image sensor 120 to capture the image data.

At block 320, the printer 100 analyzes the image data representing the printed calibration pattern to determine whether the printed calibration pattern meets a threshold calibration condition.

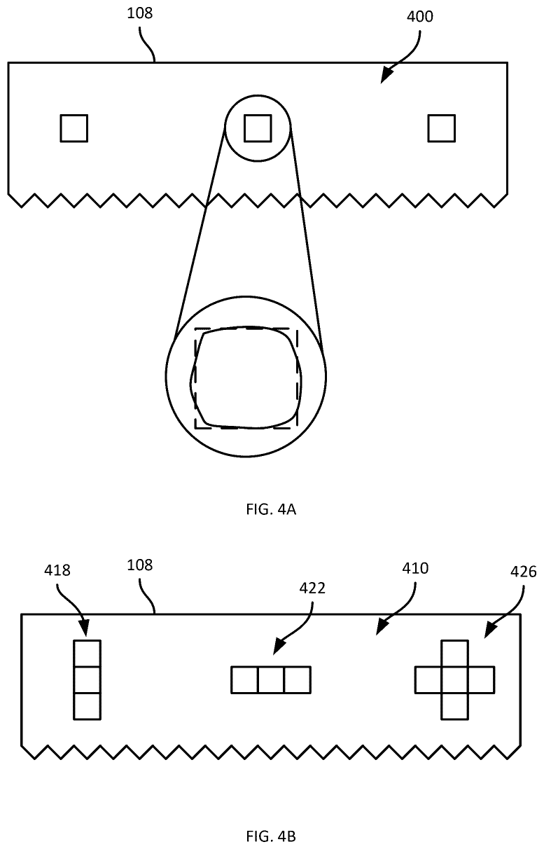

For example, the calibration pattern may include a series of individual pixels corresponding to individual dots of the printhead 104. The pixels may be analyzed to determine whether they match the dot size of the dots on the printhead 104 as the calibration threshold. For example, referring to FIG. 4A, an example calibration pattern 400 is depicted. The calibration pattern 400 includes a series of pixels 404, for example spaced across the width of the print area or pattern 400. In particular, the calibration pattern 400 may allow for calibration of individual pixel sizes. FIG. 4A further shows a close up of one of the printed pixels 404, which may be printed as a substantially square shape with rounded edges. The printer 100 may use the average of splines to create a representative square pixel 408. The square pixel 408 may then be compared to the actual dot size of the dots on the printhead 104. If the square pixel 408 is within a threshold percentage range of the actual dot size (e.g., within 95% to 105% of the actual dot size, or another suitable range), then the printer 100 may make an affirmative determination at block 320. In other examples, other suitable calibration patterns are also contemplated.

Referring to FIG. 4B, another example calibration pattern 410 is depicted. In particular, the calibration pattern 410 may include a series of neighboring pixels 414, such as adjacent pixels in a vertical line 418, a horizontal line 422, a plus shape 426, or the like. In particular, the calibration pattern 410 may allow for neighbor tuning. That is, the pixels may be analyzed to determine consistency between neighboring pixels, for example in size, shape, alignment, or other print quality, for example to ensure that the activation of neighboring dots of the printhead does not negatively affect the size and/or shape of a center pixel to no longer meet individual size and shape conditions. For example, if neighboring pixels are determined to be within a threshold percentage size range of each other, then the printer 100 may make an affirmative determination at block 320. In other examples, other suitable calibration patterns are also contemplated.

If the determination at block 320 is affirmative, that is, the printed calibration pattern meets the threshold calibration condition, then the printer 100 proceeds to block 325. At block 325, the printer 100 may store the print parameters used to print the calibration pattern which met the threshold calibration condition. For example, the printer 100 may store the print parameters in the repository 212. In some examples, the printer 100 may store the print parameters in association with the type of media 108.

If the determination at block 320 is negative, that is, the printed calibration pattern does not meet the threshold calibration condition, then the printer 100 proceeds to block 330. At block 330, the printer 100 selects one or more of the print parameters to adjust, e.g., based on an output of the trained machine learning model and/or one or more deterministic rules stored in the repository 212 for adjusting the print parameters (e.g., selections of specific print parameters and percentages or amounts by which to adjust them). The rules may further be based on the specific aspects of the printed calibration pattern (e.g., size, shape, neighbor tuning, etc.) determined to not meet the threshold calibration condition. For example, if the size of the printed pixel is determined to be oversized relative to a target size, then the printer 100 may adjust the print parameters, for example by reducing the burn time associated with the dot of the printhead that is activated to print the pixel, to produce a smaller printed pixel. In some examples, combinations of adjustments to the print parameter, such as reduction of the burn time, but increasing the pre-heat time, are also contemplated.

In some examples, blocks 320 and 330 may be performed substantially simultaneously, for example by the trained machine learning model of the application 208. That is, to perform the image analysis, the printer 100 may feed the image data of the printed calibration pattern and the print parameters into the trained machine learning model. Since the trained machine learning model may be trained on sets of input calibration patterns, print parameters, and printed calibration patterns, the machine learning model may further be configured to select adjusted values for one or more print parameters to output as output print parameters. If the output print parameters match the input print parameters, then the printer 100 may make an affirmative determination at block 320 (i.e., that the threshold calibration condition is met). If the output print parameters do not match the input print parameters, then the printer 100 may make a negative determination at block 320 and update the print parameters using the output print parameters at block 330. As an example, one or more adjusted values for the burn time, the pre-heat time, the pre-heat pulse rate, the neighbor on-time, and/or the neighbor pulse rate associated with one or more dots of the printhead can be output by the trained machine learning model, and the controller of the printer can control the one or more dots based on the one or more adjusted values.

After updating the print parameters at block 330, the printer 100 is configured to return to block 310 to print the calibration pattern according to the update print parameters and to iterate through blocks 310 through 330 until a set of print parameters allows the threshold calibration condition to be met and the printer 100 is calibrated.

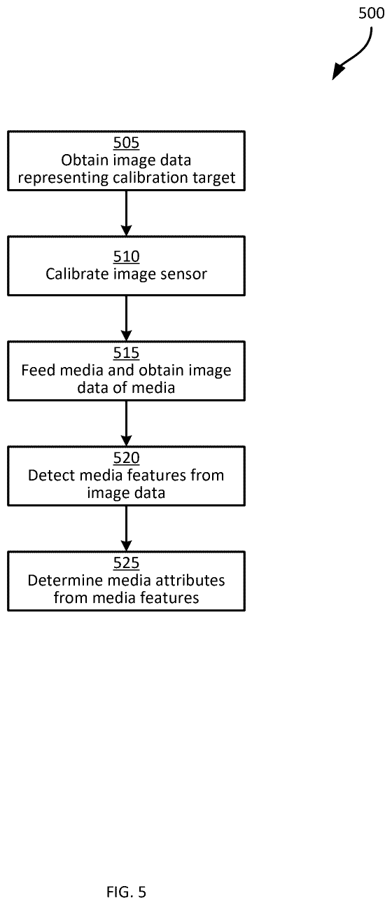

As described above, the method 300 may be employed to calibrate the print parameters, including according to different types of media 108 to optimize the print quality of the printed indicia. To optimize the calibration operation, the components of the printer 100 employed in the printer calibration operation may themselves be calibrated. For example, FIG. 5 depicts a flowchart of an example method of component calibration which may be performed as part of initializing the calibration operation at block 305.

At block 505, the printer 100 may be configured to obtain image data representing the calibration target contained in the backing 128. In particular, since the calibration target may located along the media path 116 opposite the image sensor 120, it may be blocked by the media 108 when the media 108 is fed along the media path 116. Accordingly, the image sensor calibration based on the calibration target may occur when no media is detected (or when the calibration target is successfully detected) by the image sensor 120. Alternately, if the image sensor 120 is downstream of the printhead 104, then the platen roller 112 may be configured to retract the media 108 along the media path 116 until the calibration target is visible within the field of view of the image sensor 120.

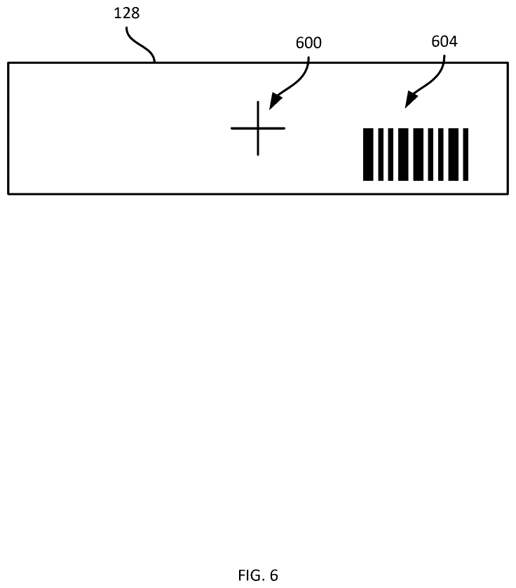

Referring to FIG. 6, an example backing 128 is depicted, including a center crosshair 600 and a barcode 604 having predefined dimensions. Accordingly, at block 505, the image sensor 120 may capture an image of the center crosshair 600 and the barcode 604. In particular, in the present example, the calibration target includes both the center crosshair 600 and the barcode 604 for different calibration aspects of the image sensor 120, as will be described further below. In other examples, other calibration targets or combinations thereof are also contemplated. For example, rather than including a separate center crosshair 600, the barcode 604 may be disposed such that a predefined portion (e.g., the top left corner) is located at the center point. In still further examples, the calibration target may include an industry standardized calibration target, such as the 1951 USAF resolution test chart or the like.

Returning to FIG. 5, in some examples, at block 505, the printer 100 may calibrate a strobe source of the image sensor 120. In particular, the image sensor 120 may be configured to vary an illumination level of the strobe source while capturing the image data of the calibration target at block 505 at a series of illumination levels.

At block 510, the printer 100 is configured to calibrate the image sensor 120 based on the image data obtained at block 505. In particular, the printer 100 may compute a pixel mapping between pixels of the image sensor 120 and actual widths of lines, for example based on mapping the pixels of portion of the image data representing the barcode 604 with predefined dimensions. The printer 100 may additionally identify a center pixel and/or region corresponding to the center crosshair 604. The printer 100 may additionally select an illumination level of the strobe source based on the quality of the calibration target represented in the image data. In particular, the printer 100 may select an illumination level for which the calibration target is uniformly but not washed out.

At block 515, the printer 100 is configured to feed the media 108 along the media path 116 to be within the field of view of the image sensor 120. The image sensor 120 may capture image data representing the media 108 within the field of view of the image sensor 120. In some examples, the printer 100 may perform additional blocks of the method 300, for example to print the calibration pattern on the media 108 before feeding it to the image sensor, to allow calibration of the components simultaneously with calibration of the print parameters. In other examples, the printer 100 may be configured to first perform the calibration of the method 500 prior to proceeding with the remainder of the method 300.

For example, during the method 500, the image sensor 120 may be configured to capture image data at a predefined time interval (e.g., 100 ms), and the printer 100 may analyze the image data for features such as the backing 128, recognizable features of the media 108, or the like. For example, if no image data is detected, the printer 100 may be open (e.g., via a door or the like).

If media is detected, then at block 520, the printer 100 is configured to analyze the image data obtained at block 515 to detect media features. For example, the printer 100 may detect whether media 108 is present, edges of the media 108, bars (or black marks) between portions of the media 108, gaps between portions of the media 108.

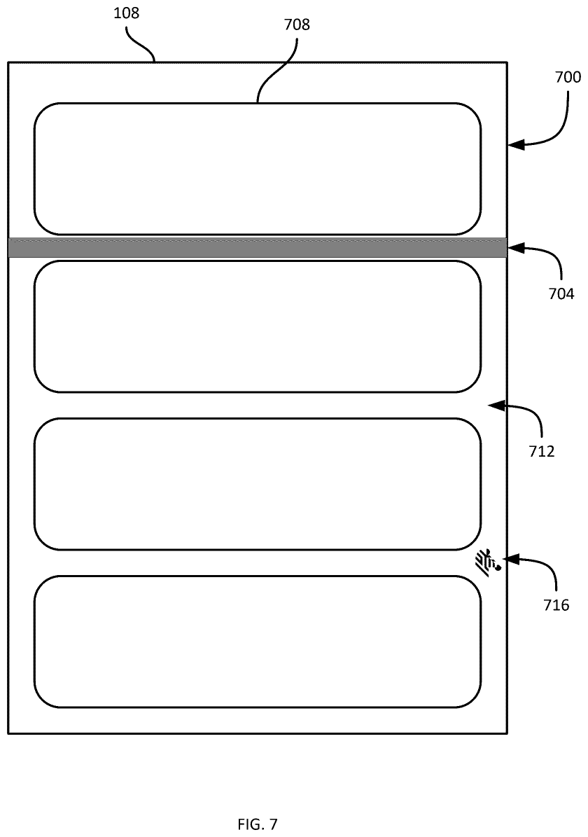

For example, referring to FIG. 7, an example media 108 is depicted. At block 520, the printer 100 may identify a substantially vertical transition from the backing 128 as an edge 700 of the media. Once the edge 700 is detected, the edge 700 may be further analyzed to determine if the transition is a single-stage transition or a two-stage transition.

In some examples, the media 108 may additionally include pre-printed bars 704, for example between labels 708 of the media 108. The bar 704 may typically be a darker color than the media 108, and hence the printer 100 may identify an area of lower optical density as the bar 704. In particular, the bar 704 may extend substantially horizontally across the image data. The printer 100 may additionally identify a width of the bar 704. In some examples, to verify the bar 704, the printer 100 may identify the vertical location (i.e., along the vertical axis of the image data) of the bar 704 and compare the detected optical densities of each pixel at that vertical location (i.e., along the row corresponding to that vertical location). If the optical densities are substantially identical across the row, the printer 100 may verify that the detected feature is the bar 704. If the optical densities vary by more than a threshold value, then the printer 100 may determine that the detected feature was a row of preprinted text or the like.

In some examples, the media 108 may additionally include gaps 712, for example between the labels 708. The gaps 712 may be detected in a similar manner as the bars 704 as a region of lower optical density relative to the labels 708.

In some examples, the media 108 may additionally include a media identifier 716, such as a logo, image, barcode, or the like. The media identifier 716 may be in the visible or infrared spectrum. In some examples, the printer 100 may apply the backlight of the backing 128 to facilitate detection of the media identifier 716. The printer 100 may apply an object recognition algorithm to identify patterns on the media 108 and authenticate the media.

In other examples, the media 108 may include other features which may be detected in the image data obtained at block 515.

Returning to FIG. 5, at block 525, the printer 100 is configured to determine media attributes from the detected features from block 520. For example, the media attributes may include a type of the media 108, a width of the media 108, and other attributes. For example, the printer 100 may use a combination of the detected media identifiers 716, bars 704 and/or gaps 712 to identify a type of the media. According to another example, the printer 100 may use the detected edge of the media 108 and a center of the printhead 104 (i.e., based on the detected center according to the center crosshair 600) to determine a width of the media 108, assuming that the media 108 is fed centered relative to the printhead 104.

The media attributes may then be applied to the calibration operation, for example to select an initial set of print parameters. Further, the media attributes such as the width may allow the printer 100 to track the location of the media 108 relative to the printhead 104 and allow for dynamic adjustments to the printed indicia if the media 108 shifts transversely within the media path 116.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A printer comprising:
a printhead configured to print indicia onto a print medium according to a set of print parameters;
an image sensor configured to capture image data representing the printed indicia on the print medium;
a controller in communication with the printhead and the image sensor, the controller configured to:
control the printhead to print a calibration pattern on the print medium;
obtain the image data from the image sensor representing the printed calibration pattern;
analyze the image data to determine whether the printed calibration pattern meets a threshold calibration condition; and
adjust the set of print parameters until the printed calibration pattern meets the calibration threshold to calibrate the printer.

2. The printer of claim 1, wherein the set of print parameters include one or more of: burn time, pre-heat time, pre-heat pulse rate, neighbor on-time and neighbor pulse rate.

3. The printer of claim 1, wherein to analyze the image data, the controller is configured to input the printed calibration pattern and the set of print parameters into a trained machine learning model.

4. The printer of claim 3, wherein the trained machine learning model is trained on sets of input calibration patterns, input print parameters, and printed calibration patterns.

5. The printer of claim 3, wherein the trained machine learning model is configured to output an adjusted value for at least one of a burn time, a pre-heat time, a pre-heat pulse rate, a neighbor on-time, or a neighbor pulse rate associated with a dot of the printhead, and
the controller controls the dot based on the adjusted value.

6. The printer of claim 1, wherein the image sensor is located upstream of the printhead, and wherein the printer further comprises a platen roller configured to retract the media with the printed calibration pattern to the image sensor to obtain the image data representing the printed calibration pattern.

7. The printer of claim 1, wherein the controller is further configured to calibrate the image sensor by:
controlling the image sensor to capture image data representing a calibration target; and
determining one or more of a pixel mapping and a center pixel corresponding a center of the printhead.

8. The printer of claim 1, wherein the controller is configured to determine a media type of the media.

9. The printer of claim 8, wherein the controller is configured to store the set of print parameters which cause the printed calibration pattern to meet the threshold calibration condition in association with the media type.

10. A method of calibrating a printer, the method comprising:
printing a calibration pattern on a print media according to a set of print parameters;
obtaining image data representing the printed calibration pattern;
analyzing the image data to determine whether the printed calibration pattern meets a threshold calibration condition; and
adjusting the set of print parameters until the printed calibration pattern meets the calibration threshold to calibrate the printer.

11. The method of claim 10, wherein the set of print parameters include one or more of: burn time, pre-heat time, pre-heat pulse rate, neighbor on-time and neighbor pulse rate.

12. The method of claim 10, wherein analyzing the image data comprises inputting the printed calibration pattern and the set of print parameters into a trained machine learning model.

13. The method of claim 12, wherein the trained machine learning model is trained on sets of input calibration patterns, input print parameters, and printed calibration patterns.

14. The method of claim 12, wherein adjusting the set of print parameters comprises:
generating, as an output of the trained machine learning model, an adjusted value for at least one of a burn time, a pre-heat time, a pre-heat pulse rate, a neighbor on-time, or a neighbor pulse rate associated with a dot of the printhead, and
controlling the dot based on the adjusted value.

15. The method of claim 10, wherein an image sensor configured to capture the image data is located upstream of a printhead configured to print the calibration pattern, the method further comprising:
retracting the media with the printed calibration pattern to the image sensor to obtain the image data representing the printed calibration pattern.

16. The method of claim 10, further comprising calibrating an image sensor of the printer by:
controlling the image sensor to capture image data representing a calibration target; and
determining one or more of a pixel mapping and a center pixel corresponding a center of a printhead of the printer.

17. The method of claim 10, further comprising determining a media type of the media.

18. The method of claim 17, further comprising storing the set of print parameters which cause the printed calibration pattern to meet the threshold calibration condition in association with the media type.
